(19) United States
(12) Patent Application Publication
(10) Pub. No.: US 2018/0345209 A1
(43) Pub. Date: Dec. 6, 2018

(54) SCAVENGERS

(71) Applicant: Hexion Inc., Columbus, OH (US)

(72) Inventors: Cyrille KAMOUN, Fulshear, TX (US); Jan Beetge, Pearland, TX (US)

(73) Assignee: Hexion Inc.

(21) Appl. No.: 15/985,800

(22) Filed: May 22, 2018

Related U.S. Application Data
(60) Provisional application No. 62/512,512, filed on May 30, 2017.

(51) Int. Cl. B01D 53/14; B01D 53/52

(52) U.S. Cl. CPC B01D 53/1493; B01D 53/52; B01D 2257/304; B01D 2252/60; B01D 2251/2067; B01D 2252/2053; B01D 2257/306

(57) ABSTRACT

The implementations described herein generally relate to methods and chemical compositions for scavenging sulfur-containing compounds, and more particularly to methods and compositions for scavenging, for example, H₂S and mercaptans from sulfur-containing streams. In one implementation, a method for scavenging a sulfur-containing compound from a sulfur-containing stream is provided. The method comprises contacting the sulfur-containing stream with a scavenging system for scavenging the sulfur-containing compound, wherein the scavenging system comprises urea formaldehyde reaction products.

### RELATED APPLICATION DATA

This application claims benefit to U.S. Provisional Application No. 62/512,512, filed May 30, 2017, of which the entire contents of the application are incorporated by reference herein.

### FIELD

The implementations described herein generally relate to methods and chemical compositions for scavenging sulfur-containing compounds, and more particularly to methods and compositions for scavenging, for example, sulfur-containing compounds such as H₂S and mercaptans from sulfur-containing streams.

### BACKGROUND

Produced crude oil often contains hydrogen sulfide (H₂S) as a contaminant from various sources in different crude oil reservoirs. H₂S is a highly undesirable gas contaminant in crude oil due to its toxicity as well as corrosive nature. H₂S is soluble in oil and water, but is released into the gas phase due to its high vapor pressure. It accumulates quickly and is present in high concentration in the gas phase, which is a hazard to operational personnel as well as any metal containment such as pipelines, process and storage equipment. The H₂S concentration can be reduced by processing crude oil in a dedicated amine plant or by chemical reaction with a H₂S scavenger additive.

Mono-ethanolamine based MEA-Triazine has been the most prevalent H₂S scavenger in use today, with mono-methyl amine, MMA-Triazine to a lesser extent. MEA-Triazine is very effective, economical and fast reacting scavenger, although solids can be formed under certain conditions, to restrict flow in valves and pipelines. Polysulfide solids formation can be avoided by careful operational control and MMA-Triazine seems to have a much lower tendency to form these undesirable solids. However, both triazines have low thermal stabilities and can easily be decomposed at higher temperatures. The use of these scavengers is limited to lower temperature operations and storage below 50° C. is often recommended. However, some scavenger applications require operational temperatures as high as 180° C. where the traditional scavengers fail to function. In one embodiment, the scavenger system may be used as temperatures from greater than 50° C. to 180° C., for example, from greater than 50° C. to 120° C.

It would be desirable if methods and compositions could be devised that would remove, reduce, eliminate, take out or otherwise remove such contaminants.

### SUMMARY

The implementations described herein generally relate to methods and chemical compositions for scavenging sulfur-containing compounds, and more particularly to methods and compositions for scavenging, for example, sulfur-containing compounds such as H₂S and mercaptans from sulfur-containing streams. In one implementation, a method for scavenging a sulfur-containing compound from a sulfur-containing stream is provided. The method comprises contacting the sulfur-containing stream with a scavenging system for scavenging the sulfur-containing compound, wherein the scavenging system comprises urea formaldehyde reaction products.

In yet another implementation, a treated stream is provided. The treated stream comprises a sulfur-containing stream, a sulfur-containing contaminant, and a multi-component scavenging system in an amount effective to at least partially remove the sulfur-containing contaminant from the sulfur-containing stream. The multi-component scavenging system urea formaldehyde reaction products.

The features, functions, and advantages that have been discussed can be achieved independently in various implementations or may be combined in yet other implementations, further details of which can be seen with reference to the following description and drawings.

### BRIEF DESCRIPTION OF ILLUSTRATIONS

So that the manner in which the above-recited features of the present disclosure can be understood in detail, a more particular description of the disclosure briefly summarized above may be had by reference to implementations, some of which are illustrated in the appended drawings. It is to be noted, however, that the appended drawings illustrate only typical implementations of this disclosure and are therefore not to be considered limiting of its scope, for the disclosure may admit to other equally effective implementations.

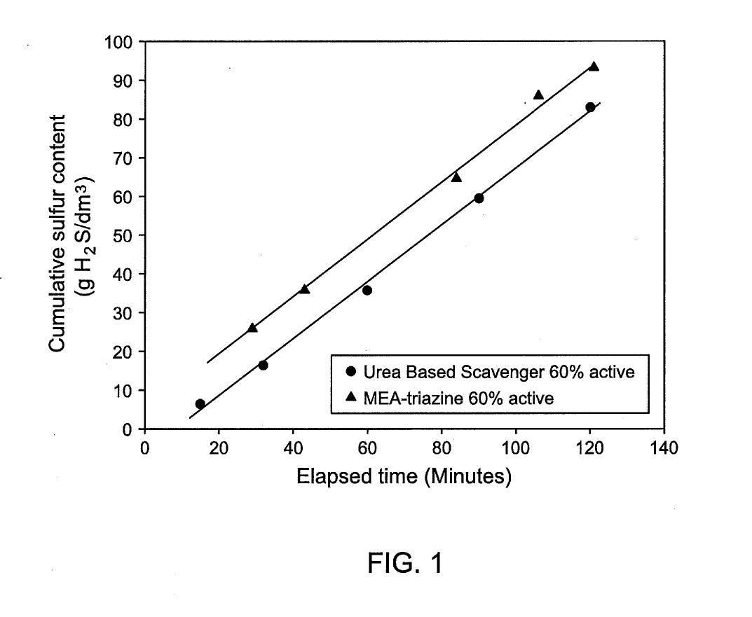

FIG. 1 is a graph illustrating the comparison of scavenger performance at ambient temperature and pressure for sulfur content of H₂S Equivalent (g/L) in the scavenging system by combustion GC analysis of the prior art monoethanolamine-triazine (“MEA-Triazine”) and the scavenger system of the present invention; and

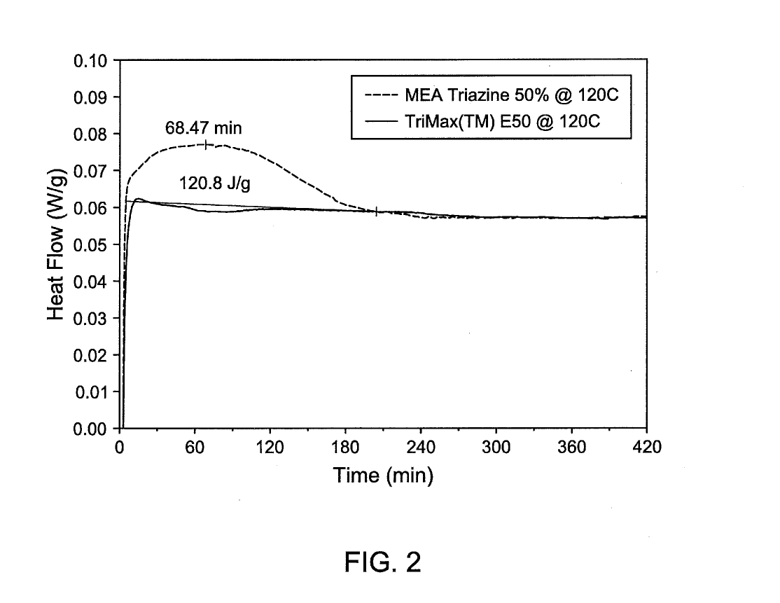

FIG. 2 is an Isothermal DSC scan at 120° C. comparing MEA-triazine with and the scavenger system of the present invention.

To facilitate understanding, identical reference numerals have been used, wherever possible, to designate identical elements that are common to the Figures. Additionally, elements of one implementation may be advantageously adapted for utilization in other implementations described herein.

### DETAILED DESCRIPTION

The following disclosure describes processes and compositions for the removal of sulfur-containing compounds from sulfur-containing streams, such as gaseous or liquid sulfur-containing hydrocarbon streams, and devices for carrying out the aforementioned process. Certain details are set forth in the following description and in FIGS. 1-2 to provide a thorough understanding of various implementations of the disclosure. Other details describing well-known methods and systems often associated with the removal of sulfur-containing compounds are not set forth in the following disclosure to avoid unnecessarily obscuring the description of the various implementations.

Many of the details, components and other features described herein are merely illustrative of particular implementations. Accordingly, other implementations can have other details, components, and features without departing from the spirit or scope of the present disclosure. In addition, further implementations of the disclosure can be practiced without several of the details described below.

As used herein, the following terms have the meaning set forth below unless otherwise stated or clear from the context of their use.

When introducing elements of the present disclosure or exemplary aspects or implementation(s) thereof, the articles “a,” “an,” “the” and “said” are intended to mean that there are one or more of the elements.

The terms “comprising,” “including” and “having” are intended to be inclusive and mean that there may be additional elements other than the listed elements.

The term “scavenger system” encompasses a combination of components or additives, whether added to a stream separately or together, that scavenge one or more of the contaminants noted herein.

The term “urea formaldehyde reaction products” refers to one or more compounds made from the reaction of urea with formaldehyde or to one or more compounds made from the reaction of methanol, air and urea in the presence of a catalyst, or a combination of both.

All percentages, preferred amounts or measurements, ranges and endpoints thereof herein are inclusive, that is, “less than about 10” includes about 10. “At least” is, thus, equivalent to “greater than or equal to,” and “at most” is, thus, equivalent “to less than or equal to.” Numbers herein have no more precision than stated. Thus, “105” includes at least from 104.5 to 105.49. Furthermore, all lists are inclusive of combinations of two or more members of the list. All ranges from a parameter described as “at least,” “greater than,” “greater than or equal to” or similarly, to a parameter described as “at most,” “up to,” “less than,” “less than or equal to” or similarly are preferred ranges regardless of the relative degree of preference indicated for each parameter. Thus a range that has an advantageous lower limit combined with a most preferred upper limit is preferred for the practice of the implementations described herein. All amounts, ratios, proportions and other measurements are by weight unless stated otherwise. All percentages refer to weight percent (wt. %) based on total composition according to the practice of the invention unless stated otherwise.

In some implementations, the sulfur-containing stream to be treated is a sulfur-containing hydrocarbon stream, especially a natural gas stream, an associated gas stream, or a refinery gas stream. Natural gas is a general term that is applied to mixtures of inert and light hydrocarbon components that are derived from natural gas wells. The main component of natural gas is methane. Further, often ethane, propane and butane are present. In some cases (small) amounts of higher hydrocarbons may be present, often indicated as natural gas liquids or condensates. Inert compounds may be present, especially nitrogen, carbon dioxide and, occasionally, helium. When produced together with oil, the natural gas is usually indicated as associated gas.

Sulfur-containing compounds, for example, hydrogen sulfide, mercaptans, sulfides, disulfides, thiophenes and aromatic mercaptans may be present in natural gas in varying amounts. Refinery streams concern crude oil derived sulfur-containing streams containing smaller or larger amounts of sulfur compounds. Also recycle streams and bleed streams of hydrotreatment processes, especially hydrodesulfurization processes, may be treated by the process according to the present disclosure.

The sulfur-containing compounds which may be removed by the processes of the present disclosure are in principle all compounds which are removed by scavengers. Usually the sulfur-containing compounds include, for example, hydrogen sulfide, carbonyl sulfide, mercaptans, organic sulfides, organic disulfides, thiophene compounds, aromatic mercaptans, or mixtures thereof. Suitable mercaptans include C₁-C₆ mercaptans, such as C₁-C₄ mercaptans. Suitable organic sulfides include di-C₁-C₄-alkyl sulfides. Suitable organic disulfides include di-C₁-C₄-alkyl disulfides. Suitable aromatic mercaptans include phenyl mercaptan.

In some implementations, the sulfur-containing stream can be a dry gaseous sulfur-containing stream. The dry gaseous sulfur-containing stream may have an amount of water less than or equal to 10 ppmV; an amount of water less than or equal to 5 ppmV; an amount of water less than or equal to 1 ppmV. The dry gaseous sulfur-containing stream may have an amount of water between 0.01 ppmV and 10 ppmV; an amount of water between 1 ppmV and 10 ppmV; an amount of water between 1 ppmV and 5 ppmV; an amount of water between 5 ppmV and 10 ppmV.

In some implementations, the sulfur-containing stream, may contain a certain amount of water, preferably up to 50% mol and more preferably less than or equal to 10,000 ppm mol.

In one implementation, a scavenger system for removing sulfur-containing compounds is provided. The scavenger system comprises urea formaldehyde reaction products. The scavenging system may further include water. The scavenging system may further include buffers, inorganic base additives selected from the group consisting of sodium hydroxide, potassium hydroxide, and combinations thereof, and combinations thereof. The scavenging system may further include one or more additives selected from the group consisting of solvents, dispersants, foam control agents, scale inhibitors, and combinations thereof. These components may be added to the sulfur-containing stream separately in any order or together as a combination or package or blend. It is expected that in most cases, the components will be added as a package for convenience.

The scavenger “scavenges” or otherwise removes or partially removes, sulfur-containing compounds from sulfur-containing hydrocarbon streams, such as crude oil streams or other hydrocarbon streams where the sulfur-containing contaminants may be present from any source. In some implementations, the scavenger includes urea formaldehyde reaction products derivable by reaction of urea with formaldehyde or derivable by reaction of methanol, air and urea in the presence of a catalyst, or a combination of products derived from both reactions. Preferably, such reactions are performed under non-acidic conditions.

In implementation where the scavenger includes urea formaldehyde reaction products derivable by reaction of urea with formaldehyde, the formaldehyde:urea mole ratio is from about 0.5:1 to about 20:1, such as from about 1:1 to about 20:1, for example from about 2:1 to about 10:1. Preferably, an excess molar amount of formaldehyde is used for the reaction. With the use of an excess molar amount of formaldehyde, free formaldehyde may be present in the urea formaldehyde reaction products. In such implementations, the free formaldehyde content may be from greater than 0% to about 70%, such as from about 10% to about 40% of the urea formaldehyde reaction products. The free formaldehyde in the urea formaldehyde reaction products could exist in as is, or exist in an acetal or hemiacetal form with water, such as methylene glycol (CAS #463-57-0) as well as with alcohols and/or polyalcohols.

In one implementation, the urea formaldehyde reaction products contain a distribution of products with primary components including, and not limited to, monomethylolurea (CAS 140-95-4) and polyhydroxymethylureas such as dimethylolurea (CAS 140-95-4), trimethylolurea (CAS 13329-70-9), tetramethylolurea (CAS 2787-01-1), and condensation products of these, such as dimethylolruron (CAS 7327-69-7). In one implementation, the urea formaldehyde reaction products are selected from the group consisting of monomethylolurea, polyhydroxymethylureas, condensation products of monomethylolurea, condensation products of polyhydroxymethylureas, and combinations thereof. The urea formaldehyde reaction products may also include unreacted urea, formaldehyde, methanol, and combinations thereof, depending on the formation reaction.

The urea formaldehyde reaction products may be present in an effective amount for removing desired amounts of the sulfur-containing compound from the sulfur-containing stream to be treated. The urea formaldehyde reaction products be present in the scavenger system in an amount from about 10% to about 90%, by weight (wt. %). For example, the urea formaldehyde reaction products be present in the scavenger system in an amount from about 40% to about 70%, by weight (wt. %). Alternatively, the urea formaldehyde reaction products are in the form of a concentrate as high as 95 wt. %, such as about 85 wt. %. Such concentrated urea formaldehyde reaction products can be diluted, or further formulated, at another location. In one implementation, the urea formaldehyde reaction products based on a concentrate is made from 60% formaldehyde and 25% urea. This reaction can occur under alkaline conditions.

Commercial examples of suitable urea formaldehyde reaction products based on concentrates include UFC-85 and CASCO™ UF85 Concentrate, all commercially available from Hexion Inc. of Columbus, Ohio.

The urea formaldehyde reaction products' chemical reactions may be performed under non-acidic conditions, with pH control by base and/or buffer addition.

In specific applications to remove H₂S from crude oil or other fluid, an effective amount of the urea formaldehyde reaction products, ranging from about 1 to about 100,000 ppm may be introduced into the sulfur-containing stream to be treated. Typical applications of the urea formaldehyde reaction products scavenger system may involve the addition of between about 1 to about 10,000 ppm (by volume); from about 10 to about 10,000 ppm; from about 50 to about 5,000 ppm; from about 100 to about 200 ppm introduced or injected into the sulfur-containing stream to be treated. Alternatively, the addition of the urea formaldehyde reaction products scavenger system may be at a rate of up to about 10 times the amount of contaminant present in the stream, in another non-limiting implementation, at a rate of up to about 5 times the amount of contaminant present. In any event, sufficient time, conditions, or both, should be permitted so that the urea formaldehyde reaction products scavenger system reacts with substantially all of the contaminant present. By “substantially all” is meant that no significant corrosion, odor, reactant problems, or a combination occur due to the presence of the contaminant(s).

It will be understood that the complete elimination of corrosion, odor or other problems or complete removal of the sulfur-containing contaminants is not required for successful practice of the method. All that is necessary for the method to be considered successful is for the treated sulfur-containing stream to have reduced amounts of the sulfur-containing contaminants as compared to an otherwise identical sulfur-containing hydrocarbon stream, sulfur-containing aqueous stream, or both, having no multi-component scavenger, and optionally, a reduced corrosion capability as compared to an otherwise identical sulfur-containing hydrocarbon stream having an absence of multi-component scavenger. Of course, complete removal of a contaminant is acceptable.

The scavenger system may also contain other additives to facilitate handling, enhance solubility of the urea formaldehyde reaction products, and avoid operational problems such as foaming and the like. The scavenger system may further comprise one or more materials selected from the group consisting of water; buffers, inorganic base additives selected from the group consisting of sodium hydroxide, potassium hydroxide, and combinations thereof, and combinations thereof; solvents, surfactants, foam control agents, scale inhibitors, and combinations thereof; and combinations thereof.

In some implementations the scavenger system further comprises water. The water may be added as part of the other components of the scavenger system or may be added as a separate component.

Water may be present in an effective amount for removing desired amounts of the sulfur-containing compound from the sulfur-containing stream to be treated. Water may be present in the scavenger system in an amount from about 10 wt. % to about 90 wt. %, such as from about 30 wt. % to about 60 wt. % of the scavenger system. Alternatively, for urea formaldehyde reaction products concentrates, the water present may be as low as 5 wt. %.

In some implementations, the scavenger system further comprises buffers. Suitable buffers include, but not limited to inorganic buffers such as sodium tetraborate and sodium phosphate as well as organic buffers such as tricine and diglycine; and combinations thereof. The buffers may be present in the scavenger system in an amount from about 0.1 wt. % to about 10 wt. %, such as from about 0.5 wt. % to about 5 wt. % of the scavenger system.

In some implementations, the scavenger system further comprises inorganic base additives. Suitable inorganic base additives include, but not limited to sodium hydroxide, potassium hydroxide or combinations thereof The inorganic base additives may be present in the scavenger system in an amount from about 0.001 wt. % to about 5 wt. %, such as from about 0.01 wt. % to about 0.1 wt. % of the scavenger system.

The scavenger system may have a pH from about 5 to about 13, such as from about 5.5 to about 11, including from about 5.5 to about 8.5, for example, from about 7 to about 8.5 or from about 6.5 to about 7.5. A neutral pH of 7 is most preferred. The pH may be maintained by the present of buffers, the inorganic base additives, and combinations thereof, which may be added with the reactants or afterwards to maintain the pH. Alternatively, the buffers, the inorganic base additives, and combinations thereof, may be added to achieve and/or maintain the pH levels described herein. It is believed that a neutral pH or pH around neutral of this scavenger system minimizes scale formation as compared to the alternative high alkalinity MEA Triazines (even in the presence of scale inhibitors), which has been observed to enhance scale formation. It particular, it has been observed that that calcium carbonate and Magnesium carbonate precipitate at alkaline pH and not at a neutral pH.

It is believed that the neutral pH of this invention, including from about 5.5 to about 8.5, and such as from about 6.5 to about 7.5, significantly reduce the risk of scale formation by using this product in applications involving high salinity brines.

In some implementations, the scavenger system further comprises a non-water solvent. Suitable non-water solvents include organic solvents that will decrease the freezing point of the scavenger system, which organic solvents are known as freeze point depressors. Suitable organic solvents for the scavenger system include, but are not necessarily limited to, formamide, propylene carbonate, tetrahydrofuran, alcohols, polyalcohols (glycols), and mixtures thereof alone or without water. Suitable alcohols and glycols include methanol, ethanol, propanol, ethylene glycol, propylene glycol, glycerol, and combinations thereof. The non-water solvent may be present in the scavenger system in an amount from about 0.1 wt. % to about 60 wt. %, such as from about 1 wt. % to about 30 wt. % of the scavenger system.

In some implementations, the scavenger system further comprises a surfactant. The surfactants may help disperse the scavenger into the treated gas stream. Suitable non-nitrogen-containing surfactants include, but are not necessarily limited to, alkoxylated alkyl alcohols and salts thereof and alkoxylated alkyl phenols and salts thereof, alkyl and aryl sulfonates, sulfates, phosphates, carboxylates, polyoxyalkyl glycols, fatty alcohols, polyoxyethylene glycol sorbitan alkyl esters, sorbitan alkyl esters, polysorbates, glucosides, and the like, and combinations thereof. Other suitable surfactants may include, but are not necessarily limited to, quaternary amine compounds, quaternary ammonium compounds, amine oxide surfactants, silicone based surfactants, and the like. These surfactants can be ionic, such as cationic surfactants such as quaternary alkyl amines or salts such as tetrabutylammomium acetate, tetrabutylammonium bromide, tetrabutylammonium nitrate, etc.; anionic surfactants such as sodium lauryl sulfate or sodium lauryl ether sulfate, or non-ionic surfactants such as polymers or copolymers based on ethylene oxide and propylene oxide and alkoxylates based on substrates such as alkylphenol or alkylphenol based resins, polyamines, other polyols, or mixtures thereof. Exemplary quaternary ammonium based surfactants include alkyl dimethyl benzyl ammonium chloride, dialkyl dimethyl ammonium chloride, didecyl dimethyl ammonium chloride, alkyl dimethyl ethyl benzyl ammonium chloride, and combinations thereof. The surfactant families can also include members from the amphoteric class, such as amine oxides, betaines, etc. Exemplary silicone based surfactants include polyether-functional siloxanes, which could be linear, branched or cyclic in configuration, with oxyalkylate pendant groups based on homopolymers, block-co-polymers or random polymers based on ethylene oxide, propylene oxide, butylene oxide or higher molecular mass epoxides, such as the TEGOSTAB® family of silicone surfactants. The surfactant may be present in the scavenger system in an amount from about 0.001 wt. % to about 5 wt. %, such as from about 0.01 wt. % to about 1 wt. % of the scavenger system.

In some implementations, the scavenger system further comprises foam control agents. Suitable foam control agents include, but not limited to copolymers of ethylene oxide and propylene oxide, alkyl poly acrylates, fatty alcohol derivatives, fatty acid derivatives, silicone based products (such as polydimethylsiloxane emulsions), or combinations thereof. The foam control agents may be present in the scavenger system in an amount from about 0.1 ppm to about 1,000 ppm, such as from about 1 ppm to about 100 ppm of the scavenger system.

In some implementations, the scavenger system further comprises a scale inhibitor. Scale inhibitors are added to produced waters from oil fields and gas fields to mitigate precipitation of minerals, especially sparingly soluble salts, present in the produced water that would occur during production and downstream processing of the water. Generally the compounds subject to producing scale are referenced as scale farmers. Those compounds include but are not limited to: hardness, metals, alkalinity (including but not limited to carbonates), sulfates, silica, and combinations thereof. Such precipitation (scaling) leads to fouling and plugging of piping, valves, process equipment, and the oil-bearing formation. Suitable scale inhibitors are typically formed from organophosphates, polyacrylic acid, polymaleic acid, hydrolyzed water-soluble copolymers of maleic anhydride, polycarboxylates, phosphonates, phosphates, sulfonates and polyamides, along with the use of polyaspartic acids, and their mixtures with surfactants and emulsifiers for inhibiting or delaying precipitation of scale forming compounds. Other suitable scale inhibitors include, but are not necessarily limited to, phosphate esters, acetylenic alcohols, fatty acids, alkyl-substituted carboxylic acids and anhydrides, polyacrylic acids, quaternary amines, sulfur-oxygen phosphates, polyphosphate esters, and combinations thereof. The at least one scale inhibitor may be present in an effective amount for mitigating precipitation of minerals occurring during production. The scale inhibitor may be present in the scavenger system in an amount from about 0.01 wt. % to about 20 wt. %, such as from about 1 wt. % to about 10 wt. % of the scavenger system.

It will be understood herein that the respective amounts of the aforementioned components and any optional components used in the detectable composition will total 100 weight percent and amounts of the above stated ranges will be adjusted if necessary to achieve the same. In another implementation the methods described herein can use the same composition amounts described above for the composition.

In one implementation, the scavenger system may include:

from about 10 wt. % to about 95 wt. % of urea-formaldehyde reaction products,

from about 10 wt. % to about 90 wt. % of water,

if present, 0.1 wt. % to about 10 wt. % of buffer,

if present, from about 0.001 wt. % to about 5 wt. % of inorganic base additives,

if present, from about 0.1 wt. % to about 60 wt. % of non-water solvent,

if present, from about 0.001 wt. % to about 5 wt. % of surfactant,

if present, from about 0.1 ppm to about 1,000 ppm of foam control agent, and

if present, from about 0.01 wt. % to about 20 wt. %, of scale inhibitor, where the respective amounts of the aforementioned components and any optional components used in the detectable composition will total 100 weight percent and amounts of the above stated ranges will be adjusted if necessary to achieve the same

In accordance with the processes of the present disclosure, the scavenger system is contacted with the sulfur-containing stream containing the sulfur-containing compounds, especially hydrogen sulfide. The contacting can be effected in any convenient manner such as by injection of the multi-component scavenger composition into a process or transport line; passing the sulfur-containing stream such as a sulfur-containing hydrocarbon stream, for example, a sulfur-containing natural gas stream through a stirred or non-stirred vessel that contains the multi-component scavenger composition; or spraying or otherwise introducing the scavenger composition for contact with the hydrocarbon stream.

In one implementation, contacting the (liquid and/or gaseous) sulfur-containing stream with the scavenger system may be achieved by liquid injection of the scavenger system into a sulfur-containing liquid stream or sprayed as a mist into a sulfur-containing gaseous stream.

In some instances, the scavenger composition can be introduced into a well hole. The hydrocarbon stream may contain other components depending upon source. Especially for natural gas streams, nitrogen, carbon dioxide and water are often present. One advantage of the multi-component scavenging system of the present disclosure is that the compositions are sufficiently robust to tolerate presence of other components in the hydrocarbon stream while still scavenging sulfur-containing compounds. The gaseous sulfur-containing streams to be treated in accordance with the present disclosure may contain from about 10 to about 100,000 ppmV of the sulfur-containing compound.

In one implementation, contacting the (liquid and/or gaseous) sulfur-containing stream with the scavenger system may be achieved by direct injection into an oil well or reservoir; directly injected into a production system, such as a production line; directly into bulk transport systems such as ships, railcars or trucks, as well as storage systems such as tanks or other storage containers.

The duration of the contact between the sulfur-containing stream and the scavenger system is sufficient to provide a treated hydrocarbon stream substantially devoid of hydrogen sulfide. A treated hydrocarbon stream substantially devoid of hydrogen sulfide may contain, for example, less than about 1 ppmV of hydrogen sulfide, such as less than about 0.01 ppmV of hydrogen sulfide. In most operations, the scavenger system is used until an undesired breakthrough of hydrogen sulfide occurs in the treated hydrocarbon stream. The temperature of the contacting can vary over a wide range and will often be determined by the temperature of the environment and the incoming hydrocarbon stream to be treated. In some implementations, the temperature is from −50 degrees Celsius and 180 degrees Celsius; such as from about 50 degrees Celsius to 140 degrees Celsius.

When the method scavenges sulfur-containing compounds from a gaseous phase, the method may be practiced by contacting the gaseous phase with droplets of the scavenger system. In one implementation, the multi-component scavenging system is sprayed into the gas stream via atomizing nozzles. Rapid and homogenous distribution of the multi-component oxygen scavenger may be achieved by the multi-component scavenger being sprayed into the gas stream (hydrocarbon stream) via atomizing nozzles. The atomized droplets may have a droplet size, for example, between 5 to 50 micrometers, such as 10 to 20 micrometers.

A suitable atomizing nozzle is any nozzle form known to those skilled in the art. The atomization is performed either due to high velocity of the liquid to be atomized, the high velocity being generated, for example, by a corresponding cross-sectional area constriction of the nozzle, or else via rapidly rotating nozzle components. Such nozzles having rapidly rotating nozzle components are, for example, high-speed rotary bells. A further possibility for atomizing the liquid is passing in addition to the liquid a gas stream through the atomizing nozzle. The liquid is entrained by the gas stream and as a result atomized into fine droplets. For very fine atomization, suitable nozzles are, in particular, atomizing nozzles in which the liquid is atomized by a gas stream, or nozzles having a relatively small bore which require a correspondingly high liquid pressure.

In an alternative embodiment, the scavenger system described herein may include a pour point modifier, for example methanol. The pour point modifier may provide a pour point below −40° C.

In an alternative embodiment, the scavenger system described herein may include a diluent, for example water. Sufficient diluent is added to produce aqueous solutions containing 50 mass % or 50 wt. % of the scavenger system. The diluent reduces the scavenger's system viscosity for ease of handling, such as pumping, and for improved diffusion and mixing of hydrogen sulfide and the scavenger system.

In one embodiment, the scavenger system herein may be diluted with water to give a pour point below −40° C. at 50% mass % (or 50 wt. %), while the flash point of an 85% solution is 75° C. as the lower limit of this product. This scavenger system may be made free of alcohols such as methanol and free of anti-freezing agents. This scavenger system has been observed to be non-flammable. It is believed that using water to further increase the flash point, while reducing the pour point, is a much more economical option compared to using methanol.

### EXAMPLES

Aspects and advantages of the implementations described herein are further illustrated by the following examples. The particular materials and amounts thereof, as well as other conditions and details, recited in these examples should not be used to limit the implementations described herein. All parts and percentages are by weight unless otherwise indicated.

### Example 1

1371.0 g of a 50% formaldehyde aqueous solution at 65° C. was measured into a 2 liter jacketed reactor equipped with agitator and connected to a circulating bath for temperature control of the reactor at a constant 80° C. 0.5 g of 50% Sodium Hydroxide was charged to adjust the pH to 8.5-9.0. 274.3 g of urea was added portion wise to the reactor to allow exotherm to raise temperature to 75-85° C. Then the rest of urea was added more slowly at regular intervals to avoid temperature excursions above 85° C. due to the strong exothermic nature of the reaction. The reaction was continued under agitation at a constant temperature of 75-85° C. for an additional 30 minutes after the last urea addition to ensure completion while pH was checked every 10 minutes. pH was adjusted with Sodium hydroxide 50% to keep pH above 7.2. The reactor content was cooled down to 40-45° C. Then the product was transferred to a 2 L-Rotovap and was distilled: 145.8 g water was extracted. The product was then cooled to 20-25° C.

1500 g product was retrieved as a clear single aqueous phase of urea-formaldehyde concentrate at 60% solid content. The 60% mass % product was used for subsequent scavenger performance testing. The reaction product is a mixture of low molecular mass oligomers of urea-formaldehyde reaction products, with some branching and ether linkages. At least the following chemical were identified from the reaction: monomethylolurea, dimethylolurea, trimethylolurea, tetramethylolurea, and dimethylolruron.

### Example 2

H₂S gas was bubbled through an aqueous scavenger solution, with analysis of the sulfur content of the solution at regular intervals. The scavenger testing was done at ambient temperature and pressure with H₂S in a mixture of 18 mole % H₂S in CO₂, fed at a controlled rate of 200 ml min⁻¹. The initial scavenger concentration was set at 60% active and the equivalent, cumulative H₂S content of the solution was calculated from sulfur analysis data, as shown in FIG. 1 (Sulfur Content of Solution as H₂S Equivalent (g/L) by combustion GC analysis). It was noted that the urea-formaldehyde based scavenger of this invention performed very similar to MEA-triazine, with almost identical scavenging rate demonstrated by the two parallel slopes in sulfur uptake or scavenging.

MEA-triazine is the workhorse compound use for H₂S scavenging in many different applications. However, it is limited in the temperature range of the application and thermal composition of the triazine can start to impact efficiency at temperatures above 60° C. Urea Formaldehyde Concentrate, in contrast shows practical thermal stability at temperatures as high as 140° C. Formulation of Urea Formaldehyde Concentrate with winterizing components such as methanol will allow operational use of the product of this invention at temperatures as low as −40° C.

FIG. 2 shows an Isothermal Differential Scanning Calorimetry plot of heat flow at 120° C. as an indication of decomposition reaction, comparing Urea Formaldehyde Concentrate (UFC-85) based scavenger with MEA-triazine at the same mass percent (activity level). No decomposition reaction was detected in the case of the urea formaldehyde based scavenger, compared to the exotherm noted for MEA-triazine equivalent under identical conditions. The device used for the plot was Universal V4.5A TA instruments.

Although the implementations described herein are typically used for scavenging sulfur-containing compounds from sulfur-containing streams, it should understood that some implementations described herein are also applicable to applications where droplets of water or water based additive are atomized/misted into a system.

While the foregoing is directed to implementations of the present disclosure, other and further implementations of the disclosure may be devised without departing from the basic scope thereof, and the scope thereof is determined by the claims that follow.

What is claimed is:

1. A method for scavenging a sulfur-containing compound from a sulfur-containing stream comprising:
contacting the sulfur-containing stream with a scavenging system for scavenging the sulfur-containing compound, wherein the scavenging system comprises urea formaldehyde reaction products.

2. The method of claim 1, wherein the scavenging system further comprises buffers, inorganic base additives selected from the group consisting of sodium hydroxide, potassium hydroxide, and combinations thereof, and combinations thereof.

3. The method of claim 2, wherein the scavenging system has a pH from 5 to 13.

4. The method of claim 1, wherein the urea formaldehyde reaction products have a formaldehyde to urea mole ratio from 0.5:1 to 20:1.

5. The method of claim 1, wherein the contacting the sulfur-containing stream with the scavenging system comprises contacting at a temperature range from about −50° C. to about 180° C.

6. The method of claim 1, wherein the urea formaldehyde reaction products have a free formaldehyde content from 0% to 70%.

7. The method of claim 1, wherein the scavenging system further comprises one or more additives selected from the group consisting of non-water solvents, dispersants, foam control agents, scale inhibitors, and combinations thereof.

8. The method of claim 7, wherein the solvents comprise alcohol and/or polyalcohol selected from the group consisting of methanol, ethylene glycol, propylene glycol, glycerol, and combinations thereof.

9. The method of claim 1, wherein the urea formaldehyde reaction products are selected from the group consisting of monomethylolurea, polyhydroxymethylureas, condensation products of monomethylolurea, condensation products of polyhydroxymethylureas, and combinations thereof.

10. The method of claim 9, wherein the urea formaldehyde reaction products are selected from the group consisting of monomethylolurea, dimethylolurea, trimethylolurea, tetramethylolurea, dimethylolruron, and combinations thereof.

11. The method of claim 1, wherein the scavenging system further comprises water, wherein the water is from about 10 wt. % to about 90 wt. % of the scavenging system.

12. The method of claim 1, wherein the urea formaldehyde reaction products comprise up to 95 wt. % of the scavenging system.

13. The method of claim 1, wherein the urea formaldehyde reaction products are obtained by the reaction of urea with formaldehyde.

14. The method of claim 13, wherein the urea formaldehyde reaction products are obtained by the reaction of 25% urea with 60% formaldehyde.

15. The method of claim 1, wherein the urea formaldehyde reaction products are obtained by reaction of methanol, air and urea in the presence of a catalyst.

16. The method of claim 1, wherein contacting the sulfur-containing stream with a scavenging system occurs at temperatures up to 180° C.

17. A treated stream comprising:
a sulfur-containing stream;
a sulfur-containing contaminant; and
a scavenging system scavenging system comprises urea formaldehyde reaction products in an amount effective to at least partially remove the sulfur-containing contaminant from the sulfur-containing stream.
